(19) United States
(12) Patent Application Publication
(10) Pub. No.: US 2003/0158700 A1
(43) Pub. Date: Aug. 21, 2003

(54) Watchdog arrangement

(76) Inventors: Joseph Wayne Forler, Zionsville, IN (US); Mark Alan Nierzwick, Brownsburg, IN (US); William John Testin, Indianapolis, IN (US)

Correspondence Address: Joeseph S Tripoli, Thomson Multimedia Licensing Inc, P O Box 5312, Princeton, NJ, 08543-5312, US

(21) Appl. No.: 10/296,898

(22) PCT Filed: May 24, 2001
(86) PCT No.: PCT/US01/16750

(51) Int. Cl. G04F 1/00; G04F 3/00; G04F 5/00; G04G 5/00; G04G 7/00; G04F 8/00; G04F 10/00; G06F 15/00; G04G 15/00; G04F 7/00

(52) U.S. Cl. 702/178

(57) ABSTRACT

A watchdog arrangement advantageously provides systems, such as television signal processing apparatus, with a reliable, cost effective means by which to maintain consistent, stable operation. According to at least one embodiment, a hardware watchdog circuit receives regular pulses from a software timer in an integrated circuit (IC) to refresh itself. In the event that the watchdog circuit is not refreshed, it provides a predetermined logic signal to a non-maskable interrupt (NMI) terminal of the IC to generate a reset similar to what is generated by an internal IC watchdog.

### BACKGROUND OF THE INVENTION

1. Field of the Invention

The present invention relates generally to the use of watchdog circuits in electrical systems, and more particularly to a watchdog arrangement which provides systems, such as consumer electronics products, with a reliable, cost effective means by which to maintain consistent, stable operation.

2. Description of the Related Art

Applications controlled by integrated circuits such as microprocessors often include “watchdog” circuits. In general, watchdog circuits function to monitor and/or correct the operational status of an electrical device. In applications involving integrated circuits including software, watchdogs may be used to monitor the status of software execution. In complex applications where it is difficult to test every possible variation of the software, watchdog timers provide an efficient means for correcting conditions where the software fails to execute properly. For example, systems such as a television signal processing apparatus having an integrated circuit (IC) such as a microprocessor for processing data such as electronic program guide (EPG) data or other types of data require a watchdog timer due to the complexity of the software. In particular, such systems require a watchdog to allow recovery from errors in execution of the software that may result from transients, noise or other system anomalies. One example of such an anomaly is an electrostatic discharge (ESD) or Kine-Arc transient in a television signal receiver that includes a kinescope display device. However, the invention is also applicable to various systems, either with or without display devices, and the phrases “television signal receiver”, “television system”, “television signal processing system”, or “television signal processing apparatus” as used herein are intended to encompass various types of apparatus and systems including, but not limited to, television sets or monitors that include a display device, and systems or apparatus such as a set-top box, video tape recorder, DVD, video game box, or personal video recorder (PVR) that do not include display devices. In such devices, an address bit may become momentarily corrupted by an anomaly, which could force the software to jump to an unspecified address and cause the system to lockup.

Various problems exist with conventional watchdog circuits. For example, it has been observed that internal IC watchdogs can fire randomly due to a race condition with certain values of a countdown timer. Standard off-the-shelf watchdog timers tend to be relatively expensive, making them undesirable for cost reduction designs. Moreover, off-the-shelf watchdogs may not be feasible for certain designs due to limited circuit space. In addition, watchdog circuits should have a time constant sufficient to handle various design scenarios. Accordingly, there is a need for a watchdog circuit arrangement addressing these and other problems.

### SUMMARY OF THE INVENTION

The present invention provides a watchdog arrangement for an integrated circuit, such as a microprocessor embodied in an electrical system such as a television signal processing apparatus that includes first and second watchdogs. The first watchdog is included internal to an integrated circuit for monitoring an operational state of the integrated circuit. The first watchdog is implemented at least in part by software. According to at least one embodiment, the second watchdog includes hardware external to the integrated circuit. An aspect of the invention is that the second watchdog provides redundancy. The second watchdog enables the integrated circuit to be reset in response to electrical signals provided by the integrated circuit. In particular, the second watchdog enables the integrated circuit to be reset by applying a predetermined logic signal to a predetermined terminal (i.e., the non-maskable interrupt terminal) of the integrated circuit when the integrated circuit fails to provide electrical signals to the second watchdog for a given period of time. The second watchdog is useful for protecting the integrated circuit against operational errors or anomalies caused by signal transients such as electrostatic discharges and/or Kine-Arc transients.

According to another embodiment, a watchdog arrangement includes an integrated circuit such as a microprocessor having first and second watchdogs for monitoring an operational state of the integrated circuit. The second watchdog resets the first watchdog when a predetermined condition of the first watchdog is detected. In this embodiment, the first and second watchdogs are implemented at least in part by software.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic diagram of a system employing a first embodiment of a watchdog arrangement constructed according to principles of the present invention;

FIG. 2 is a schematic diagram of a system employing a second embodiment of a watchdog arrangement constructed according to principles of the present invention;

FIG. 3 is a schematic diagram of a system employing a third embodiment of a watchdog arrangement constructed according to principles of the present invention; and

FIG. 4 is a flowchart illustrating the operation of a fourth embodiment of a watchdog arrangement constructed according to principles of the present invention.

Throughout the drawings, like reference characters are used to represent the same or similar types of components. The exemplifications set out herein illustrate preferred embodiments of the invention, and such exemplifications are not to be construed as limiting the scope of the present invention in any manner.

### DETAILED DESCRIPTION OF THE INVENTION

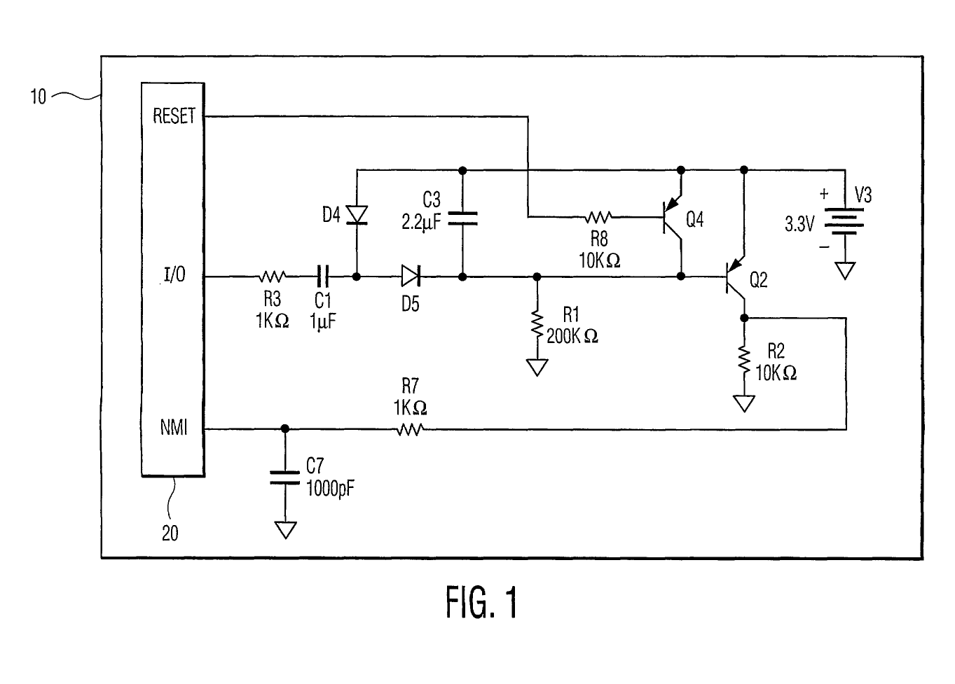

Referring now to the drawings, and more particularly to FIG. 1, a schematic diagram of a system employing a first embodiment of a watchdog circuit arrangement constructed according to principles of the present invention is shown. In FIG. 1, a system 10 such as a television signal processing apparatus includes an integrated circuit (IC) 20 such as a microprocessor. IC 20 includes a reset terminal, an input/output (I/O) terminal, and a non-maskable interrupt (NMI) terminal. IC 20 also includes at least one internal watchdog which monitors and/or corrects the operational state of IC 20. This internal watchdog typically serves as the primary watchdog for IC 20, and enables IC 20 to be reset in situations where, for example, software routines within IC 20 fail to execute properly. According to an embodiment, the internal watchdog of IC 20 includes two counters (not shown in FIGS). One counter is set by software within IC 20 to control the amount of time before the watchdog expires and resets IC 20. According to the embodiment, this first counter has a 100 microsecond resolution. There is also a second counter (i.e., a prescaler) that is driven by a 4 MHz clock of system 10 and counts down from 400 to 1. Each time this second counter reaches 1, the first counter is decremented and the second counter starts over again. Since there is no way for the software to directly access the second counter, if the first counter is reset by the software when the second counter has a value of 2, for example, the first counter will shortly thereafter behave as if the watchdog has expired and reset IC 20 again. As will be described hereinafter, all embodiments of the present invention include a primary internal watchdog, such as the aforementioned one.

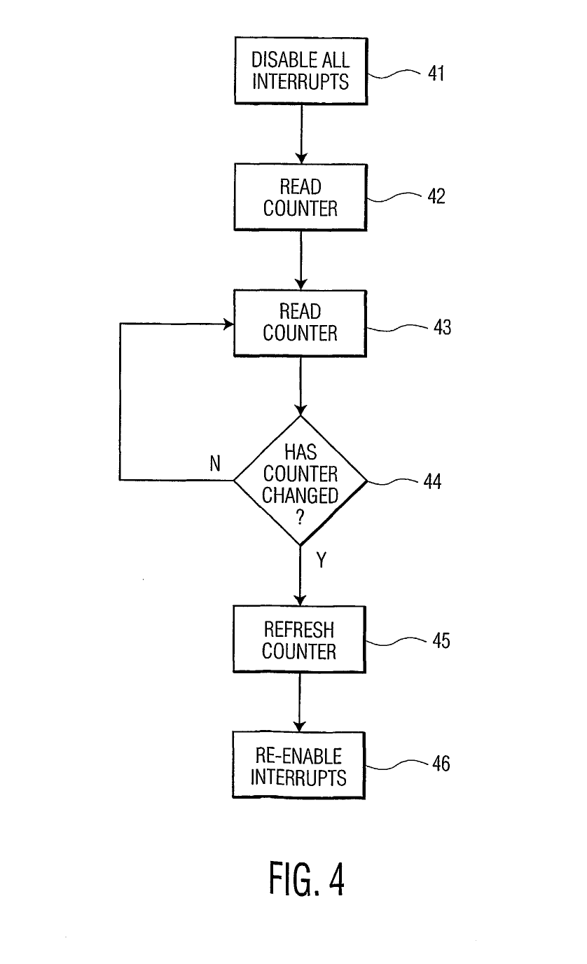

Due to conditions, such as the aforementioned one involving the two counters, it has been observed that a primary internal watchdog alone may not be sufficient for consistent, reliable system operation. Accordingly, a secondary watchdog is desirable for operating cooperatively with the primary watchdog to enhance reliability. The present invention contemplates four different embodiments for such a secondary watchdog. The first three embodiments are implemented in hardware external to IC 20, and are referred to in FIGS. 1-3, respectively. The fourth embodiment is a software implementation internal to IC 20, and is referred to in FIG. 4.

Referring back to FIG. 1, the circuitry external to IC 20 represents a first embodiment of a secondary, hardware watchdog circuit used in conjunction with the aforementioned internal watchdog to monitor the operational state of IC 20. In this manner, the internal watchdog of IC 20 and the external hardware watchdog provide a watchdog arrangement that ensures the operational integrity of IC 20 (and ultimately system 10). The external watchdog circuit of FIG. 1 includes five resistors R1, R2, R3, R7 and R8, three capacitors C1, C3 and C7, two diodes D4 and D5, two transistors Q2 and Q4, and one voltage source V3. Preferred values for these circuit components are illustrated in FIG. 1.

During operation of FIG. 1, a 40 millisecond square wave is output from the I/O terminal of IC 20. An internal software loop may be used to generate the timing, and samples of various software routines may be sampled on a regular basis to determine whether the IC 20 is operating properly. The square wave from the I/O terminal charges capacitor C1 on high-to-low transitions, and energy is transferred to capacitor C3 on low-to-high transitions. During normal operation, the side of capacitor C3 connected to the base of transistor Q2 is charged to approximately 5.3 volts. Under that condition, transistor Q2 is turned off and resistor R2 maintains the NMI terminal of IC 20 in a logic low state. Since the NMI terminal is edge sensitive, the NMI is not active. In the event that one of the software routines is not properly refreshing the watchdog circuit, the pulses out of the I/O terminal of IC 20 stop. Since this output is alternating current (AC) coupled, the watchdog circuit does not care what polarity the output ends up in when a watchdog timeout occurs. Without electrical charge feeding capacitor C3, resistor R1 eventually discharges capacitor C3. When the voltage on the base of transistor Q2 drops to 2.7 volts (i.e., 0.6 volts below the emitter at 3.3 volts), transistor Q2 turns on and the low-to-high transition provides a logic high signal to the NMI terminal. This input to the NMI terminal forces software within IC 20 to the reset vector which then re-initializes (i.e., resets) IC 20.

To ensure that the voltage on capacitor C3 is a known value after an AC power dropout period, transistor Q4 is provided. Transistor Q4 is turned on by the reset terminal of IC 20. A logic low state is present on the reset terminal during every AC power dropout period. This logic low state turns transistor Q4 on and saturates it, which forces zero volts across capacitor C3. This ensures that the initial condition of the circuit is constant. The reset terminal may be used directly to pull the base of transistor Q2 to a logic low state, but this affects the rise and fall time of IC 20's reset function, which may not be acceptable in certain scenarios. The circuit of FIG. 1 also sets up at least two unique time constants. Assuming that IC 20 takes 1 second before initializing the I/O terminal (and the time constant of charging capacitor C3 from zero volts to 0.6 volts is approximately 0.4 seconds), a watchdog reset is generated approximately 0.4 seconds after the system 10 (e.g., television signal processing apparatus) is provided with electrical power. Without transistor Q4 initially setting the voltage on capacitor C3 to zero, it may take up to 3 times longer before an actual initialization occurs. Since this would delay a user's ability to turn on the system 10, a delay of less than 500 milliseconds is preferred. Once the I/O terminal of IC 20 is initialized, any drop of more than approximately 1.4 seconds (which is approximately 3 time constants of capacitor C3 and resistor R1) will generate an actual watchdog timeout. In order to prevent leakage problems, capacitor C3 is preferably chosen as a multi-layer chip capacitor, rather than an electrolytic. Capacitor C7 is provided to prevent ESD and Kine-Arc transients from arbitrarily generating watchdog timeouts.

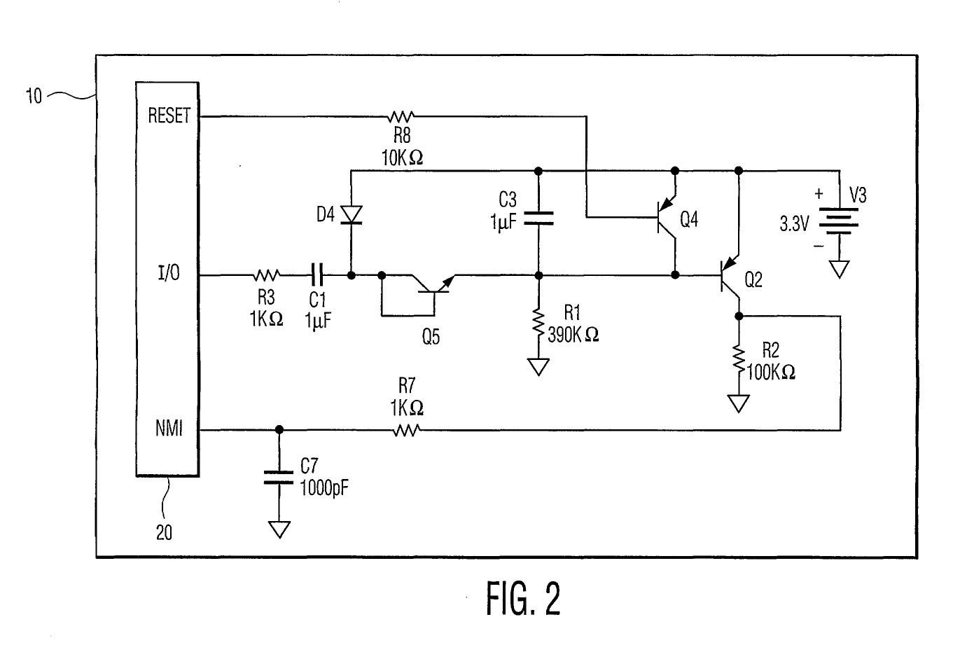

Referring now to FIG. 2, a schematic diagram of a system employing a second embodiment of a watchdog circuit arrangement constructed according to principles of the present invention is illustrated. The circuit of FIG. 2 is a variation of the circuit of FIG. 1 and operates to reset IC 20 in the same general manner. Additionally, the circuit of FIG. 2 employs many of the same circuit components as the circuit of FIG. 1, although their values may be different. Preferred values for the circuit components in this embodiment are illustrated in FIG. 2. Like FIG. 1, IC 20 in FIG. 2 also includes the previously described internal watchdog which monitors the operational state of IC 20. Accordingly, the hardware circuit of FIG. 2 operates cooperatively with the internal watchdog and is designed to provide a longer time constant than the circuit of FIG. 1. Computer simulations indicate that the leakage of diode D5 in FIG. 1 could be significant and, as a result, the maximum value of resistor R1 is preferably limited to 200K ohms. The circuit of FIG. 2 addresses this leakage problem by replacing diode D5 of FIG. 1 with the base-emitter junction of a transistor Q5. With the base area of a small signal transistor being much less than that of a typical diode, the saturation current (which is essentially leakage current) is also much lower. By substituting transistor Q5 for diode D5, the circuit of FIG. 2 can more than double the time constant of the circuit of FIG. 1.

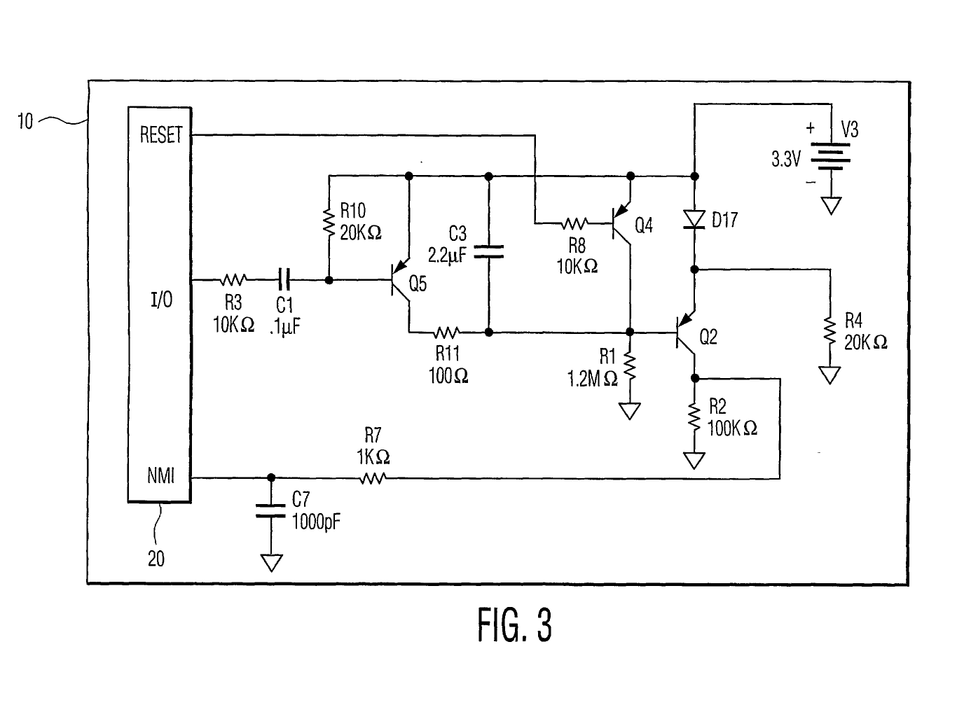

Referring now to FIG. 3, a schematic diagram of a system employing a third embodiment of a watchdog circuit arrangement constructed according to principles of the present invention is shown. Like FIG. 2, the circuit of FIG. 3 is another variation of the circuit of FIG. 1 and employs many of the same circuit components, although their values may be different. Preferred values for the circuit components in this embodiment are illustrated in FIG. 3. Note that IC 20 in FIG. 3 also includes the previously described internal watchdog which monitors the operational state of IC 20. The circuit of FIG. 3, however, is different from the circuit of FIG. 1 in that it includes some additional components, namely three resistors R4, R10 and R11, one transistor Q5, and one diode D17. In addition, the circuit of FIG. 3 does not employ diodes D4 and D5 of FIG. 1. The circuit of FIG. 3 was designed to further increase the time constant. This is achieved by increasing the voltage that capacitor C3 charges to before transistor Q2 turns on. By adding diode D17 in FIG. 3, the trigger voltage oh transistor Q2 increases to approximately 1.4 volts (assuming a standard transistor and diode). By adding resistor R4, a predictable current is forced through diode D17 making its voltage drop very consistent.

Referring now to FIG. 4, a flowchart illustrating the operation of a fourth embodiment of a watchdog arrangement constructed according to principles of the present invention is shown. This fourth embodiment is a software implementation suitable for use in an IC, such as IC 20 in FIGS. 1-3. In this manner, the software watchdog depicted in FIG. 4 will serve as a secondary internal watchdog to the primary internal watchdog of IC 20 described previously herein. An aspect of the fourth embodiment involves reading the first counter of the primary watchdog to see when it is decremented. Once it is decremented, this indicates that the second counter of the primary watchdog has just rolled over and started counting down again from 400. Once the first counter is decremented, the secondary software watchdog has a limited amount of time (just under 100 microseconds in the exemplary embodiment) to refresh the first counter before the second counter reaches a count value of 2 again. To ensure that no uncertainty exists in the timing, all interrupts of IC 20 are disabled while the first counter is polled. The interrupts are not enabled again until after the first counter is refreshed. FIG. 4 illustrates this operation of the software implemented secondary watchdog, and will hereinafter be described.

In step 41, the secondary watchdog causes all interrupts of IC 20 to be disabled. Next, in step 42, the first counter of the primary watchdog is read for a first time. The first counter is read again in step 43. Then, in step 44, it is determined whether or not the count value of the first counter has changed between the first and second readings in steps 42 and 43. If the count value has not changed, process flow loops back to step 43 and the first counter is read again. If the count value of the first counter has changed, process flow advances to step 45 where the first counter is refreshed (i.e., initialized to zero). Finally, in step 46, the interrupts of IC 20 are re-enabled.

As described herein, the present invention advantageously provides several variations for a watchdog arrangement that ensures stable, consistent operation of an electrical system. Although described herein in relation to a television signal processing apparatus, the present invention may be applicable to any audio, video or other consumer electronics device, such as a video cassette recorder (VCR), digital satellite apparatus, digital video disc (DVD) player, compact disc player, computer, or similar system.

While this invention has been described as having a preferred design, the present invention can be further modified within the spirit and scope of this disclosure. This application is therefore intended to cover any variations, uses, and/or adaptations of the invention using its general principles. Further, this application is intended to cover such departures from the present disclosure as come within known or customary practice in the art to which this invention pertains and which fall within the limits of the appended claims.

1. A watchdog circuit arrangement, comprising:
an integrated circuit including a first watchdog for monitoring an operational state of the integrated circuit; and
a second watchdog external to the integrated circuit, wherein the second watchdog enables the integrated circuit to be reset in dependence upon receiving electrical signals provided by the integrated circuit.

2. The watchdog circuit arrangement of claim 1, wherein the first watchdog is implemented at least in part by software, and the second watchdog is implemented by hardware.

3. The watchdog circuit arrangement of claim 1, wherein the integrated circuit comprises a microprocessor.

4. The watchdog circuit arrangement of claim 1, wherein the first and second watchdogs are embodied in a consumer electronics device.

5. The watchdog circuit arrangement of claim 4, wherein the consumer electronics device comprises a television signal processing apparatus.

6. The watchdog circuit arrangement of claim 1, wherein the second watchdog protects the integrated circuit against electrostatic discharges.

7. The watchdog circuit arrangement of claim 1, wherein the second watchdog protects the integrated circuit against Kine-Arc transients.

8. The watchdog circuit arrangement of claim 1, wherein the second watchdog enables the integrated circuit to be reset in response to the integrated circuit failing to provide the electrical signals to the second watchdog for a given period of time.

9. The watchdog circuit arrangement of claim 1, wherein the second watchdog enables the integrated circuit to be reset by applying a predetermined logic signal to a terminal of the integrated circuit.

10. The watchdog circuit arrangement of claim 9, wherein the terminal of the integrated circuit is a non-maskable interrupt terminal.

11. A watchdog arrangement, comprising:
an integrated circuit including first and second watchdogs for monitoring an operational state of the integrated circuit, wherein the second watchdog resets the first watchdog in response to a predetermined condition of the first watchdog.

12. The watchdog arrangement of claim 11, wherein the first and second watchdogs are implemented at least in part by software.

13. The watchdog arrangement of claim 11, wherein the integrated circuit comprises a microprocessor.

14. The watchdog arrangement of claim 11, wherein the first and second watchdogs are embodied in a consumer electronics device.

15. The watchdog arrangement of claim 14, wherein the consumer electronics device comprises a television signal processing apparatus.

16. A method for providing a watchdog function for an integrated circuit, comprising steps of:
providing a first watchdog internal to the integrated circuit for monitoring an operational state of the integrated circuit; and
providing a second watchdog external to the integrated circuit for enabling the integrated circuit to be reset in response to electrical signals provided by the integrated circuit.

17. The method of claim 16, wherein the first watchdog is implemented at least in part by software, and the second watchdog is implemented by hardware.

18. The method of claim 16, wherein the integrated circuit comprises a microprocessor.

19. The method of claim 16, wherein the first and second watchdogs are embodied in a consumer electronics device.

20. The method of claim 19, wherein the consumer electronics device comprises a television signal processing apparatus.

21. The method of claim 16, wherein the second watchdog protects the integrated circuit against electrostatic discharges.

22. The method of claim 16, wherein the second watchdog protects the integrated circuit against Kine-Arc transients.

23. The method of claim 16, wherein the second watchdog enables the integrated circuit to be reset in response to the integrated circuit failing to provide the electrical signals to the second watchdog for a given period of time.

24. The method of claim 16, wherein the second watchdog enables the integrated circuit to be reset by applying a predetermined logic signal to a terminal of the integrated circuit.

25. The method of claim 24, wherein the terminal of the integrated circuit is a non-maskable interrupt terminal.
